(19) United States
(12) Patent Application Publication
(10) Pub. No.: US 2022/0358589 A1
(43) Pub. Date: Nov. 10, 2022

(54) ELECTRONIC TRADING PLATFORM

(71) Applicant: Eagle IS Consulting, LLC, Atlanta, GA (US)

(72) Inventors: Christian Tooley, Atlanta, GA (US); Ted Chappell, Atlanta, GA (US)

(21) Appl. No.: 17/737,889

(22) Filed: May 5, 2022

Related U.S. Application Data
(60) Provisional application No. 63/184,316, filed on May 5, 2021.

(51) Int. Cl. G06Q 40/04

(52) U.S. Cl. CPC G06Q 40/04

(57) ABSTRACT

In one aspect, the present disclosure relates to an electronic trading platform comprising hardware and/or software configured to create a user profile. The trading platform may associate an automated trading strategy with the user profile, and may modify the automated trading strategy based on one or more user preferences of the user profile. The electronic trading platform may execute a trade based on the modified automated trading strategy without user involvement in the trade.

### RELATED APPLICATION

Under provisions of 35 U.S.C. § 119(e), the Applicant claims benefit of U.S. Provisional Application No. 63/184,316 filed on May 5, 2021, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to platforms, methods, and systems for electronic stock trading.

### BACKGROUND

Many users and retail investors do not have the time, nor the energy to monitor the markets every second of every day. This often causes problems because the common retail trader lacks guidance and information needed to make timely and effective stock trades. Accordingly, there remains a need for a trading platform for retail investors with an ability to passively trade on their behalf using user defined strategies. This need and other needs are met by the various aspects of the present disclosure.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In one aspect, the present disclosure relates to an electronic platform that includes a user interface (UI) module having a user input module configured to receive user inputs and order inputs, and a trading strategy module configured to create a trading strategy protocol with trading parameters and rules and order execution logic. The platform includes a processing module. The processing module has a data mining module comprising a data scraping and collecting function configured to collect a plurality of trading data relevant to stocks or holdings (e.g., market level data, socio-cultural data, technological data, economic data, political data, environmental data, legal data, and/or the like); a processing module database configured to store at least one of user input data or data collected from the data mining module; an attribution module configured to associate data collected from the data mining module to stocks or holdings using attributes; and an analytics processing module configured to receive data from the data mining module, the processing module database, and the user input module, and perform a process providing a plurality of analytics relating to a user. The platform includes a management module comprising: an execution module having one or more trade execution requests based at least on analytics from the analytics processing module and a selected trading strategy.

In another aspect, the present disclosure relates to a method for making automated stock trades, the method comprising: requesting user input data from a user, the user input data including a plurality of user input requests and trade strategy request to the user; receiving a trade strategy selection and plurality of user inputs from the user; collecting a plurality of trading data relevant to stocks or holdings (e.g., market level data, socio-cultural data, technological data, economic data, political data, environmental data and legal data); analyzing the plurality of user inputs, selected trading strategy, and the trading data; and executing at least one trade, wherein executing the at least one trade is based on the analysis and comprises refining data on the plurality correlations.

It should be understood that examples mentioned in the present description, such as methods related to trading stocks, only reflect a portion of the context to which the present disclosure pertains. Problems addressed by the embodiments disclosed also occur in a variety of other contexts. Information provided in the context of stock trading systems is provided only for contextual reference to certain use cases to which the various embodiments in the present disclosure may apply. Other use cases may generally include, but are not limited to, any other system having data metrics related to trading securities, assets, commodities or the like.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart of a method for providing an electronic trading platform;

FIG. 3 is a flow chart of a method for providing an electronic trading platform;

FIG. 4 is a flow chart of a method for maintaining a user marketplace on an electronic trading platform; and

FIG. 5 is a block diagram of a system including a computing device for performing any disclosed method.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of platforms, methods, and systems for trading stocks, embodiments of the present disclosure are not limited to use only in this context.

### I. Technical Advantages

The present disclosure takes a data driven & community focused approach to engineering a solution in stock trading. Some of the platforms, systems, and methods of the present disclosure may be powered by algorithms developed by machine learning, data collection and attribution, and statistical analysis. Further, some embodiments may solve issues of effort required to make timely, effective trades and empower consumers and amateur traders with automatic trading based on market research and/or algorithms and crowd-sourced trading strategies.

### II. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

Embodiments of the present disclosure may comprise methods, systems, and a computer readable medium comprising, but not limited to, at least one of the following:
A User Interface (UI) Module;
A User Input Module;
A Trading Strategy Module;
A Processing Module;
A Data Mining Module;
An Attribution Module;
An Analytics Module;
A Management Module Layer;
An Execution Module;
A Report Module; and
An API Layer.

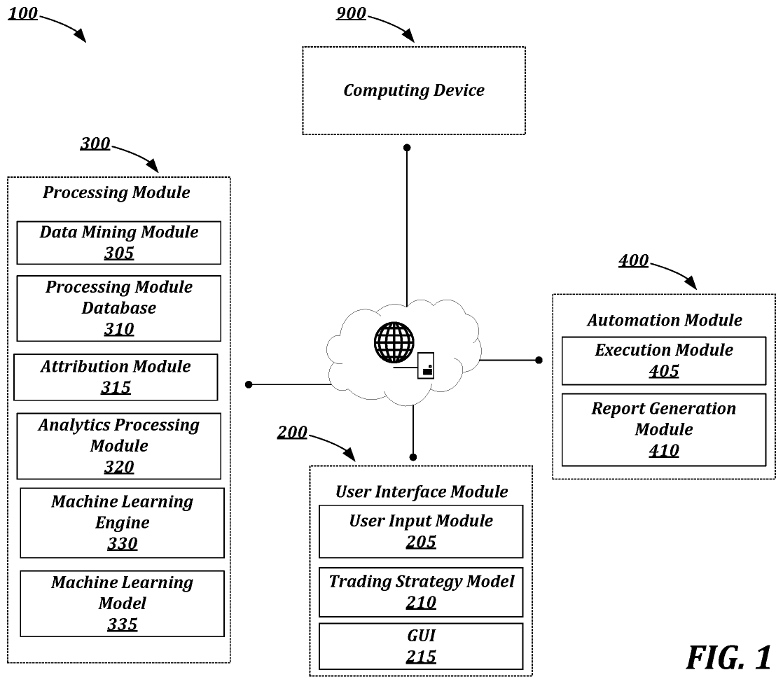

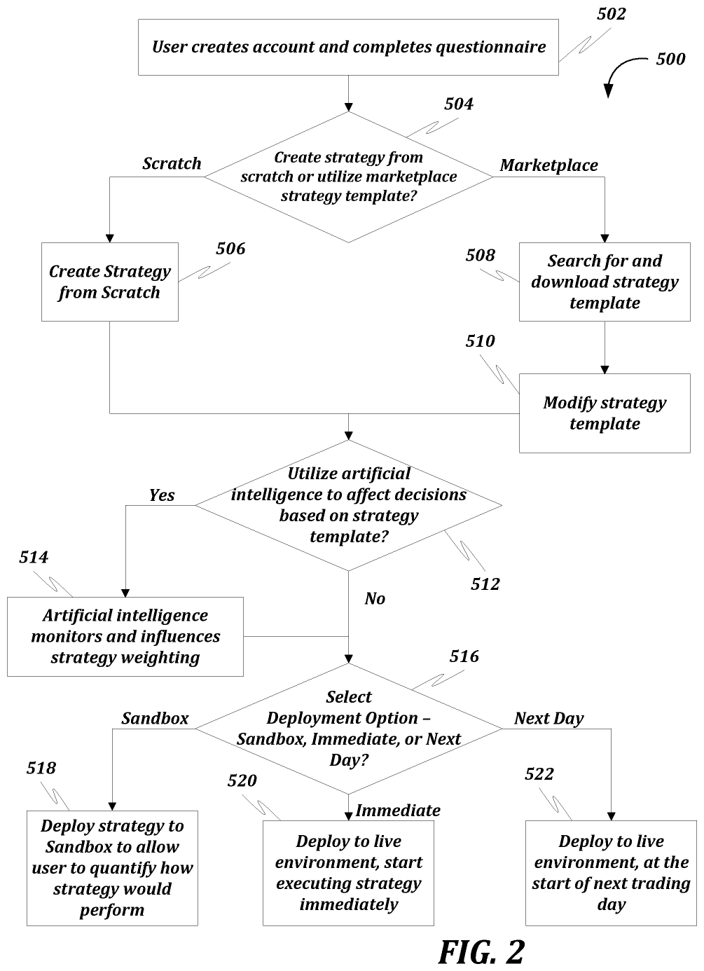

FIG. 1 illustrates a block diagram of an operating environment consistent with the present disclosure. FIG. 2 illustrates another block diagram of an operating environment consistent with the present disclosure. Details with regards to each module is provided below. Although modules are disclosed with specific functionality, it should be understood that functionality may be shared between modules, with some functions split between modules, while other functions duplicated by the modules. Furthermore, the name of the module should not be construed as limiting upon the functionality of the module. Moreover, each stage disclosed within each module can be considered independently without the context of the other stages within the same module or different modules. Each stage may contain language defined in other portions of this specifications. Each stage disclosed for one module may be mixed with the operational stages of another module. In the present disclosure, each stage can be claimed on its own and/or interchangeably with other stages of other modules.

The present disclosure aims to solve issues related to electronic trading by providing a platform to electronically trade stocks on multiple exchanges in one or more of an “active” management (e.g., triggered by an action from a user at a specific date and time) and/or “passive” management (e.g., automatically triggered based on collected data, algorithms and specific trading strategies). In some aspects, the platform may allow users to publish user-created strategies to a strategy marketplace inside the platform. The platform may allow users to download strategies and optionally customize the downloaded strategy. The user may employ the downloaded (and optionally customized) strategy to govern the “passive” management option of the platform. In some aspects, the strategies may vary from user to user, and can serve as a template for other users to customize and make new strategies. Accordingly, the present platform enables users not only the ability to actively manage by executing on their desired trades manually, but also enables users to employ predefined trading strategies. The platform may employ an AI engine to execute trades automatically based on strategy parameters and trading rules or rules engine, and data attributable to stocks analyzed by a management engine or module. To this end, a user does not have to monitor their account or portfolio every day, nor use a high commission broker in order to be successful in the market.

In some aspects, the present disclosure relates to a trading rules engine configured to define conditions for executing one or more actions for affecting an order or a trade.

In some aspects, the present disclosure relates to a trading rules engine configured to execute the one or more actions for affecting an order or trade.

In some aspects, the present disclosure relates to a management engine configured to, by way of non-limiting example, monitor, analyze, project, optimize, define, and/or execute one or more actions for management of stocks or holdings.

In some aspects, the present disclosure relates to artificial intelligence and/or machine learning methods and systems for the autonomous or quasi-autonomous provisioning and control of various aspects of investing and portfolio management.

The following depicts an example of a method of a plurality of methods that may be performed by at least one of the aforementioned modules, or components thereof. Various hardware components may be used at the various stages of operations disclosed with reference to each module. For example, although methods may be described to be performed by a single computing device, it should be understood that, in some embodiments, different operations may be performed by different networked elements in operative communication with the computing device. For example, at least one computing device 900 may be employed in the performance of some or all of the stages disclosed with regard to the methods. Similarly, an apparatus may be employed in the performance of some or all of the stages of the methods. As such, the apparatus may comprise at least those architectural components as found in computing device 900.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

Consistent with embodiments of the present disclosure, a method may be performed by at least one of the modules disclosed herein. The method may be embodied as, for example, but not limited to, computer instructions, which when executed, perform the method. In various aspects, embodiments of the present disclosure may provide a system comprising:
a user interface (UI) module,
   wherein the UI module provides an interface for at least one of the following:
   creating a user profile with a plurality of user input data;
   opening an order with a generation or creation of an order object,
   accepting or executing the order and complete the order object, and creating a trading strategy with a generation or creation of a trading strategy object or template;
selection of a trading strategy object, wherein the trading strategy object is enabled to view the user input data and open and execute orders on behalf of a user.
a processing module,
wherein the processing module is configured to perform at least one of the following:
   collect data related to stocks and holdings,
   associate the collected data to stocks or holding using attributes;
   analyze the attribution data according to predetermined criteria, and
a management module,
   wherein the management module is configured to perform at least one of the following:
      generating and/or executing order object based on at least one of:
         a selection or instruction from a user, or
         instruction from order logic associated with a trading strategy,
wherein the instruction from the order logic is at least based on the analyzed attribution data.

Embodiments of the present disclosure may provide the aforementioned system, wherein the order or order object represents a stock trade.

Embodiments of the present disclosure may provide the aforementioned system, wherein the management module is configured to perform at least one of the following:
monitor activity associated with holdings or a brokerage account,
monitor activity associated with one or more stocks,
monitor activity associated with one or more orders,
request validation for the activity associated with an order,
receive validation for the activity associated with an order, and
permit activity by at least one of the following:
   a user, or
   a trading strategy module.

Embodiments of the present disclosure may provide the aforementioned system, wherein the trading strategy object specifies the parameters to be used for governing the generation or execution of a trade or order.

Embodiments of the present disclosure may provide the aforementioned system, further comprising a trading strategy marketplace for selecting a trading strategy object or template.

Embodiments of the present disclosure may provide the aforementioned system, wherein the management module is configured to perform, based at least in part on parameters of the trading strategy object or template, including but not limited to at least one of the following:
generate one or more orders;
execute one or more orders;
track one or more orders;
add items (stocks) to the collection;
P/L Threshold
AI influence weighting
   Budget Setting

Embodiments of the present disclosure may provide the aforementioned system, wherein the order object specifies or instructs at least one of the following:
open one or more positions associated with one or more stocks;
close one or more positions associated with one or more stocks;
add to and/or reduce one or more positions associated with one or more stocks;

Embodiments of the present disclosure may provide the aforementioned system, wherein the order object specifies the parameters to be used for governing or executing the order.

In further aspects, an API layer may be configured to enable a system of communication or action between various modules and layers, for example, the trading strategy module and the management module.

Although the aforementioned method has been described to be performed by the platform 100, it should be understood that computing device 900 may be used to perform the various stages of the method. Furthermore, in some embodiments, different operations may be performed by different networked elements in operative communication with computing device 900. For example, a plurality of computing devices may be employed in the performance of some or all of the stages in the aforementioned method. Moreover, a plurality of computing devices may be configured much like a single computing device 900. Similarly, an apparatus may be employed in the performance of some or all stages in the method. The apparatus may also be configured much like computing device 900.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### III. Platform Configuration

FIG. 1 illustrates one possible operating environment through which a platform consistent with embodiments of the present disclosure may be provided. By way of non-limiting example, an electronic trading platform 100 may be hosted on, for example, a cloud computing service. In some embodiments, the platform 100 may be hosted on a computing device 900. A user may access platform 100 through a software application and/or hardware device. The software application may be embodied as, for example, but not be limited to, a website, a web application, a desktop application, and a mobile application compatible with the computing device 900. One possible embodiment of the software application and/or hardware device may be provided by the EagleISC™ suite of products and services.

Accordingly, embodiments of the present disclosure provide a software and hardware platform comprised of a distributed set of computing elements, including, but not limited to:

A. User Interface Module

FIG. 1 illustrates a user interface module 200 consistent with embodiments of the present disclosure. The user interface module 200 may comprise hardware and/or software configured to receive one or more commands from a user and/or to relay information to a user. In some embodiments, user interface module 200 may include a user input module 205 comprising a plurality of user input requests. In some embodiments, the user input module 200 may comprise a user input database. In some embodiments, user interface module 200 may comprise a trading strategy module 210 comprising a trading strategy object or protocol based at least on user defined rules and/or user input data. In some embodiments, user interface module 200 may comprise a trading strategy database or repository. In some embodiments, the user input module 200 may comprise a Graphical User Interface (“GUI”) 215.

a. User Input Module

In various aspects, user input module may comprise hardware and/or software configured to provide user input requests and/or receive user inputs. In some embodiments, user input requests may be configured to receive a plurality of user inputs. A plurality of user input requests may be embodied as, for example, a questionnaire, a test, an assessment, and/or an examination.

In some embodiments, user inputs may comprise a plurality of identification input requests. The plurality of identification input requests may comprise, but not be limited to, at least one of the following:
1. a name,
2. a biometric identification,
3. a username,
4. a user image,
5. an age,
6. a date of birth,
7. an email address,
8. a password,
9. a two-step verification,
10. an identity verification,
11. a plurality of contact information,
12. a Broker Authentication,
13. a human verification, and
14. an identification card scan.

In embodiments, a plurality of user input requests may comprise a plurality of user trading input requests. In some embodiments, the user trading input requests may be used to create a user trading profile. The user trading profile may comprise, for example, user trading profile data corresponding to attributes of a user's investment goals and/or preferences. In some embodiments, the plurality of user trading input requests may comprise, but not be limited to, at least one of the following:
1. brokerage account information,
2. inquiries related to trading history,
3. inquiries related to investment goals,
4. inquires related to types of stocks,
5. preference of industry,
6. preference for digital currency,
7. preference of engagement with system,
8. level of autonomous account management by the system;
9. general investment interests, and
10. risk preferences.

As an example, in some embodiments, the user may go through an exercise (e.g., a questionnaire, a quiz, a test, etc.) to create a user trading “profile” by selecting a subset of attributes or establishing criteria that may be important to the user's trading preferences and/or investing goals. In aspects, for each attribute selected, the user may indicate an importance of each selected attribute (e.g., by associating each attribute with a weighted value, buy ranking each attribute from most important to least important, etc.). Additionally or alternatively, the user may indicate, of an attribute, the most important attribute value and the least important attribute value (a “max differ” attribute value selection). Thus, in some aspects, the user profile may be used to compute one or more user trading scores indicating a degree of compatibility or “matching” with one or more available trading strategies. Further, the one or more user trading scores may be presented to the user to indicate relative matches between the user (or user preferences) and the corresponding trading strategy.

In some aspects, attributes may be grouped into categories for presentation purposes, and selection of at least one attribute from each or any given category or categories may optionally be enforced as part of a trading strategy matcher feature. To this end, a user who creates a trading strategy may create a profile representing the trading strategy's parameters and preferences related to attributes and/or attribute values for the user-investor type and/or asset category type, and the like.

In some embodiments, a full set of attributes may be presented to the user along with a brief description of one or more (e.g., each) of the attributes to help the user understand the meaning and/or purpose of the attribute. The user may select the set of attributes that may be most important from the user's perspective (e.g., attributes that most align with the user's fiscal philosophy and/or desired investment strategy) in selecting a specific trading strategy. A minimum and/or maximum number of selected attributes may be enforced during the attribute selection process. Attribute categories may be used, where the attributes may be displayed within the groups and any rules associated with enforcing selection of attributes from the attribute categories may be enforced. The user may use a rating process to provide relative ratings to the values for each selected attribute. All of the possible attribute values for a particular attribute may be presented, and the user may select the single “most important” and/or single “least important” value for the particular attribute from his or her perspective.

In some embodiments, a maximum differential (“Max Diff”) approach may be used in the matcher to provide an efficient way to get a relative rating for the possible values for each selected attribute. A first attribute value may be identified (e.g., selected by the user) as having the maximum relative importance, a second attribute value may be identified (e.g., selected by the user) as having the least relative importance, and other attribute values may be assumed to have a mid-level relative importance to the user. In this way, the maximum differential approach may provide a relative rating for all possible attribute values, with one identified as having the maximum relative value, one the minimum relative value, and the rest an equal middle relative value. For attributes with small numbers of values, the matcher may provide a good relative rating for values. As the number of values for a given attribute increases, the larger number of values with the equivalent middle relative values may make differentiating matching values between attribute values less clear. Further, tuning and/or adjusting may be performed for such attributes to improve the match scoring.

Non-limiting examples of attributes may include those listed above and/or one or more of: calculated trading strategy performance rating, average trading strategy rating by users, average star rating with location, performance history with platform, number of subscribed users, and others.

In some embodiments, user inputs may comprise one or more order inputs and/or one or more order input requests. In some embodiments, order inputs may comprise, but not be limited to, instructions that effect order generation and/or execution. An order, order object, or the like may be created based on the order input. The order input may be created passively (e.g., by the platform) or actively (e.g., by a user). For example, a user of the platform, such as a trader, may specify parameters of an active order into the system. In some embodiments, not all of the parameters may be specified. For example, the parameters specified by the user in the order may vary based on whether the order is a buy order or a sell order. The user may create the active order through the user interface module, which may vary based on user type. The user interface may be provided by, for example, but not limited to, a GUI.

Once the order is created (e.g., either actively or passively), in some embodiments, the order may be transmitted or otherwise shared, so as to be discoverable by a brokerage or clearing house. Transmitting may comprise, but not be limited to, a publication of the order on and/or through a desired medium. In some embodiments, the medium may be selected by the user. The medium may comprise, but not be limited to, for example: a text message (e.g., an SMS message), an e-mail, a social network, a website, Morse code, or any other communication forum.

Still consistent with embodiments of the present disclosure, the order may be boarded by the platform. Here, the order may be added as an order in the order book on the platform.

It should be understood that order management may be performed using the management module layer and a selected trading strategy. The selected trading strategy may, in turn, employ rules as specified, at least in part, in a strategy rules engine, order object and/or order execution logic. Accordingly, the platform may enable autonomous management of trader activities under the governance of the strategy rules engine and/or order execution logic employed by the order when created through a trading strategy protocol. Only some of the available functions provided by the platform are disclosed in the following embodiments. It should be understood that all conventional trading capabilities may be configured so as to be provided by the platform.

In various aspects, a trading UI, as provided by the UI module may be used by the user to manage a trade represented by one or more orders, including, but not limited to, for example, opening of trades and closing of trades. In some embodiments, the trading UI may present a plurality of trading strategies for the user to select to manage trading. The plurality of trading strategies presented to the user by the trading UI may be based at least in part on matching rules and user inputs. In some embodiments, the plurality of trading strategies may be organized via, including but not limited to, at least one of the following:
a ranking system,
a percentage/percentile match system,
a visual and/or graphical representation, and/or
past performance with graphical representation.

It should be understood that the trading may be managed and controlled by a selected trading strategy and management module of the platform. This may include, but not be limited to, for example, creation, execution, and tracking of orders and holdings.

In some aspects, the trading UI may invoke a method to display retrieved and/or calculated values for the funds under management, as well as the values of other assets that the user may desire to engage. The trading UI may receive an order or trade request initiated by the user (or by a trading strategy selected by the user) and communicate the order to the management module or directly to an electronic trading exchange or clearinghouse. For example, the order may be received or transmitted through an API layer. To this end, the API layer may directly transmit to either a brokerage or clearinghouse.

In some embodiments, the received order or trade request may be sent to a designated module for approval. The designated module may approve or decline the request based on verifications. The verifications may be based on, at least in part, the order parameters and/or trading strategy parameters. Responsive to approval by the designated module, a trade may be executed. Various embodiments may execute the trade in different ways. For example, when a user adds a particular holding to his or her selected trading strategy within the platform, once that particular holding falls within the parameters of the user selected trading strategy, the trade may be executed via an API call to the user's designated Broker.

In some aspects, a user input database may be provided. In some embodiments, a user input database may be configured to record and/or store data and information associated with user inputs and order inputs.

b. Trading Strategy Module

In some aspects, the user interface module 200 may include a trading strategy module 210. Trading Strategy Module may comprise hardware and/or software configured to create a trading strategy represented by a trading strategy object or protocol based at least on user defined trading objectives, order execution logic, trading rules, parameters and/or user input data from strategy input requests. In various aspects, the trading strategy module 210 may be configured to provide strategy input requests. In some embodiments, user input requests may be configured to receive a plurality of trading strategy inputs. A plurality of strategy input requests may be embodied as, for example, a query, a questionnaire, a test, an assessment, and/or an examination.

In some embodiments, the plurality of strategy input requests may comprise, but not be limited to, at least one of the following:
1. Risk strategy
2. Order execution logic and rules
3. Trading parameters
4. Profit/Loss Threshold
5. Industry
6. Manual or AI driven execution
7. Real-Time or Daily
8. Current or Past Performance
9. Overall Market Movement

Upon receiving user defined rules, parameters and/or user strategy input data from strategy input requests, the trading strategy module 210 may enable generation of a trading strategy object, template or protocol. A trading strategy database or repository may also be provided. In embodiments, the trading strategy database may record, register, and/or store trading strategies, trading data, and/or information associated with strategy input requests. As is discussed herein, a strategy that is recorded, registered, or stored in the trading strategy database may be published in a marketplace for selecting a strategy object. Accordingly, embodiments of the present disclosure may provide a trading strategy module that provide certain key features, including, but not limited to:

### Strategy Creation/Registration

A strategy may be created by any user at any time.
A created strategy may be designated as public (e.g., viewable by any user) or private (e.g., only viewable to user-creator).
Public strategies may be automatically registered in a strategy registry and/or posted to the strategy marketplace
Risk parameters and trading parameters of a strategy are published.
The strategy may be publicly vetted and accepted (e.g., by rating the strategy).

### Strategy Responsibilities

Oversee positions taken
Keep track of trades
Make trades
Control trade execution logic
Monitoring of accounts and positions

### Strategy Marketplace

Includes registered or public strategies
Contains all registered and publicly available strategies
Contains public and/or platform performance rating associated with each strategy
User trader can select a strategy created by self or a publicly available strategy created by another user
Publishes past performance benchmark data associated with the strategy

In various embodiments, when a user downloads or selects a trading strategy or trading strategy template provided by the platform, the user may be required to change at least one parameter or attribute or input a minimal amount of user-specific data for the trading strategy to be operable on the user's account. For example, in response to a selection made a user, the platform may provide a trading strategy template to the user. In some embodiments, the trading strategy template is inactive and may require a user to customize the strategy and/or provide user-specific inputs and preferences before the trading strategy is complete and is active and operational on the platform. To this end, the platform may, in some embodiments, require a minimum level of user interaction, settings, and template customization before the user may be able to utilize certain features of the platform, such as autonomous features. In still further aspects, the user may be required to acknowledge and release the platform from liabilities for trading activity performed autonomously by the platform based on the selected trading strategy.

In further aspects, the Strategy Marketplace may be embodied as a social media-type forum that provide one or more features, including, but not limited to:

Strategy Templates which may be user modifiable

Active and passive management

User selectable level of autonomy

Trading strategy metrics including (but not limited to) one or more of:
Previous Close
Open
Bid, Ask
Day's Range
Average Volume
Market Cap
Beta
PE Ratio
EPS
Earning's Date
Dividend & Yield
Ex-Dividend Date

Predefined Trading Strategies
Trend-following Strategies
Arbitrage Opportunities
Index Fund Rebalancing
Mathematical Model-based Strategies
Trading Range (Mean Reversion)
Volume-weighted Average Price (VWAP)
Time Weighted Average Price (TWAP)
Percentage of Volume (POV)
Subscription-based strategies
Real0time text and data feeds read from social media and/or message boards

Customizable strategies

Downloadable strategy templates and/or user defined strategies

Modification of templates to create user defined AI strategies

Publishing of user generated investment strategies as a new template

In some aspects, a user feedback loop may be employed, wherein trading strategies may include ratings from users and performance ratings used to determine an overall rating.

c. GUI

In some aspects, the user interface module 200 may include a GUI 215. The GUI 215 may include hardware and/or software configured to display user input requests, strategy input requests, and order inputs. In embodiments, the GUI 215 may be configured to receive plurality of user input requests, strategy inputs, and/or order inputs from the user. In some embodiments, the GUI 215 may be configured to display and/or grant access to the user input database and/or the trading strategy database.

B. Processing Module

As shown in FIG. 1, the platform 100 may include a processing module 300 consistent with embodiments of the present disclosure. In some embodiments, the processing module 300 may comprise a data mining module 305. In some embodiments, the processing module 300 may comprise a processing module database 310. In yet further embodiments, processing module 300 may comprise an attribution module 315. In even further embodiments, processing module 300 may comprise an analytics processing module 320.

In yet further embodiments, processing module 300 may comprise a machine learning (“ML”) capability. In still further embodiments, the processing module may comprise an artificial intelligence (“AI”) capability. To this end, the processing module 300 may include an artificial intelligence, such as a machine learning engine 330. In particular, the machine learning engine 330 may be used for autonomous or quasi-autonomous provisioning and control of various aspects of investing and portfolio management. Machine learning includes various techniques in the field of artificial intelligence that deal with computer-implemented, user-independent processes for solving problems that have variable inputs.

In some embodiments, the machine learning engine 330 trains a machine learning model 335 to perform one or more operations. Training a machine learning model 335 uses training data to generate a function that, given one or more inputs to the machine learning model 335, computes a corresponding output. The output may correspond to a prediction based on prior machine learning. In an embodiment, the output includes a label, classification, and/or categorization assigned to the provided input(s). The machine learning model 335 corresponds to a learned model for performing the desired operation(s) (e.g., labeling, classifying, and/or categorizing inputs). The processing module 300 may use multiple machine learning engines 330 and/or multiple machine learning models 335 for different purposes.

In an embodiment, the machine learning engine 330 may use supervised learning, semi-supervised learning, unsupervised learning, reinforcement learning, and/or another training method or combination thereof. In supervised learning, labeled training data includes input/output pairs in which each input is labeled with a desired output (e.g., a label, classification, and/or categorization), also referred to as a supervisory signal. In semi-supervised learning, some inputs are associated with supervisory signals and other inputs are not associated with supervisory signals. In unsupervised learning, the training data does not include supervisory signals. Reinforcement learning uses a feedback system in which the machine learning engine 330 receives positive and/or negative reinforcement in the process of attempting to solve a particular problem (e.g., to optimize performance in a particular scenario, according to one or more predefined performance criteria). One example of a network for use in reinforcement learning is a recurrent neural network, which may include a backpropagation or feedback pathway to correct or improve the response of the network.

In an embodiment, a machine learning engine 330 may use many different techniques to label, classify, and/or categorize inputs. A machine learning engine 330 may transform inputs (e.g., the extracted network features) into feature vectors that describe one or more properties (“features”) of the inputs. The machine learning engine 330 may label, classify, and/or categorize the inputs based on the feature vectors. Alternatively or additionally, a machine learning engine 330 may use clustering (also referred to as cluster analysis) to identify commonalities in the inputs. The machine learning engine 330 may group (i.e., cluster) the inputs based on those commonalities. The machine learning engine 330 may use hierarchical clustering, k-means clustering, and/or another clustering method or combination thereof. For example, the machine learning engine 330 may receive, as inputs, one or more extracted network features, and may identify one or more entity classifications based on commonalities between the received extracted network features and network features associated with networks corresponding to classified entities. In an embodiment, a machine learning engine 330 includes an artificial neural network. An artificial neural network includes multiple nodes (also referred to as artificial neurons) and edges between nodes. Edges may be associated with corresponding weights that represent the strengths of connections between nodes, which the machine learning engine 330 adjusts as machine learning proceeds. Alternatively or additionally, a machine learning engine 330 may include a support vector machine. A support vector machine represents inputs as vectors. The machine learning engine 330 may label, classify, and/or categorizes inputs based on the vectors. Alternatively or additionally, the machine learning engine 330 may use a naïve Bayes classifier to label, classify, and/or categorize inputs. Alternatively or additionally, given a particular input, a machine learning model may apply a decision tree to predict an output for the given input. Alternatively or additionally, a machine learning engine 330 may apply fuzzy logic in situations where labeling, classifying, and/or categorizing an input among a fixed set of mutually exclusive options is impossible or impractical. The aforementioned machine learning model 335 and techniques are discussed for exemplary purposes only and should not be construed as limiting one or more embodiments.

In an embodiment, as a machine learning engine 330 applies different inputs to a machine learning model 335, the corresponding outputs are not always accurate. As an example, the machine learning engine 330 may use supervised learning to train a machine learning model 335. After training the machine learning model 335, if a subsequent input is identical to an input that was included in labeled training data and the output is identical to the supervisory signal in the training data, then output is certain to be accurate. If an input is different from inputs that were included in labeled training data, then the machine learning engine 330 may generate a corresponding output that is inaccurate or of uncertain accuracy. In addition to producing a particular output for a given input, the machine learning engine 330 may be configured to produce an indicator representing a confidence (or lack thereof) in the accuracy of the output. A confidence indicator may include a numeric score, a Boolean value, and/or any other kind of indicator that corresponds to a confidence (or lack thereof) in the accuracy of the output

a. Data Mining Module

As discussed above, the processing module 300 may include a data mining module 305. In some embodiments, the data mining module 305 may comprise hardware and/or software configured for data collecting, crawling and/or scraping functions. The data collecting, crawling and/or scraping functions implemented using the data mining module 305 may be configured to perform, for example, data scanning, data recording, data collecting, data copying, and/or data analysis.

In some embodiments, the data collecting, crawling and/or scraping functions implemented using the data mining module 305 may be configured to crawl or scrape at least one of a database, the Internet, a social media site, a message board, a news source, a financial analyst site, a website, an email account, a financial data source, and/or a neural network.

As an example, the data mining module 305 may use the data collecting, crawling and/or scraping functions to “crawl” (e.g., systematically review data stored at) a webpage for publicly available relevant info that may be associated with or attributable to stocks or holdings. In some aspects, the data mining module 305 may be configured to identify and collect data associated with or corresponding to various factors, including trading rules, metrics, investment strategies, political, economic, social, technology, environmental, and/or legal factors, and/or regulatory bodies. In some embodiments, the collected data may be presented directly to a user. Additionally or alternatively, the collected data may be stored for later processing and analyzing by the platform.

In some aspects, data may be collected when the data relates to factors associated with a country's economic system. There is a wide array of economic system factors, such as (but not limited to): a current and/or future foreign policy of a country, bilateral relations between two countries, the stability of a country's political system, freedom of press, the level of bureaucracy and corruption, lobbying, security policy, trade policy and governmental regulation and deregulation. The economic system factors may further include, for example, customs policy (e.g., import and export duties), export subsidies, and tax guidelines. The economic system may further include non-tariff trade barriers, such as import surveillance measures, bans and restrictions on exports, and setting minimum import prices. Economic factors may include funding and subsidies of various industries and/or organizations within a country. In some embodiments, broad economic factors, including economic growth, gross domestic product, population, production conditions, consumer behavior, capital flow, import/export regulations, stock market trends, and credit availability may be collected. The economic factors for collection may include interest rate fluctuations, price fluctuations, recession data, exchange rate fluctuations, inflation data, unemployment rate data, labor cost fluctuations, resource scarcity, rising average income, an increase in investments in the target sector, and rising demand.

In some aspects, data may be collected when the data relates to socio-cultural factors associated with a country. For example, the socio-cultural factors, may include demographics information, such as age distribution, social classes, life expectancy, population growth rate, language, wealth distribution, level of education, and family size and structure. In some embodiments, the socio-cultural factors that collected may include Standards, values and attitudes such as health consciousness, shopping habits, understanding of one's societal role (e.g., gender roles, age-related roles, etc.), religion, and trends.

In some aspects, data may be collected when the data relates to technological factors associated with a country. For example, the technological factors, may include (but not be limited to) government expenditure on research and development, the level of innovation, access to new technologies, and disruptive technologies.

In some aspects, data may be collected when the data relates to environmental factors associated with a country. For example, the environmental factors, may include (but not be limited to) physical and geographical features such as climate, topography, country size, infrastructure, and the availability of natural resources (e.g., raw materials, mineral resources). In some embodiments, environmental factors for collection may include environmental pollution data (e.g., emissions, waste), environmental awareness data, pressure from NGOs, adoption of sustainable products, and recycling standards.

In some aspects, data may be collected when the data relates to legal factors associated with a country. For example, the legal factors, may include (but not be limited to) competition laws, antitrust laws, environmental regulations, consumer protection laws, occupational health and safety requirements, merger and acquisition laws, data protection laws, copyright and patent laws, liabilities, manufacturing standards, and labeling regulations.

b. Processing Module Database

In embodiments, the processing module 300 may include a processing module database 310. In some embodiments, the processing module database 310 may comprise information, metrics, and/or data related to data collected using the data mining module 305, at least one stock or asset, and/or at least one industry. In embodiments, the processing module database may store the data on one or more computer-readable storage devices.

c. Attribution Module

In embodiments, the processing module 300 may include an attribution module 315. In some embodiments, the attribution module 315 may include hardware and/or software configured to associate, normalize, reconcile, and/or reformat data stored in the processing module database 310 and/or data collected by the user interface module. By way of nonlimiting example, data collected using the data mining module 305 may be ingested from external sites and then associated with a stock or holding, based on data attributes, using the attribution module 315.

d. Analytics Module

In embodiments, the processing module 300 may include an Analytics module 320. In some embodiments, the analytics module 320 may include hardware and/or software configured to make comparisons by, at least in part, weighing the attributed data and/or using a statistical based correlation metric. In some embodiments, the analytics module 320 may be configured to provide a plurality of analytics, attributed data, weighed data, calculated data, and/or statistical data. For example, the analytics module may receive, as inputs, data from one or more of the user interface module, the processing module; and the management module. The analytics module may provide, as output, analytics associated with the input data.

In some embodiments, the analytics and/or the attributed data may be configured to be used in conjunction with trading strategies. For example, the analytics and/or the attributed data may be used to help determine when to buy, when to sell, and/or how much to execute.

C. Automation Module

As shown in FIG. 1, the platform 100 may include an automation module 400 consistent with embodiments of the present disclosure. The automation module 400 may include hardware and/or software configured to execute one or more orders. The automation module 400 may include hardware and/or software configured to generate one or more reports. In some embodiments, the automation module 400 may comprise an execution module 405. In some embodiments, the automation module 400 may comprise a report generation module 410.

a. Execution Module

In some embodiments, the automation module 400 may include an execution module 405. The execution module 405 may comprise include hardware and/or software configured to execute one or more order executions. In some embodiments, the order execution may be based at least in part on data and analytics from the processing module and a selected trading strategy. In some embodiments, the order execution may be based on, at least in part, data and analytics from processing module 300, at least one trading parameter, rule, and/or order execution logic. In some embodiments, the order execution may comprise and/or provide, including but not limited to, at least one sell order request, and/or at least one buy order request.

In some embodiments, the execution module may provide at least one trading recommendation, which may comprise a recommended buy, a recommended sell, a recommended stock monitoring, or the like.

b. Report Generation Module

In some embodiments, the automation module 400 may include a report generation module 410. The report generation module 410 may include hardware and/or software configured to generate a one or more reports and/or summaries. The reports and/or summaries may be displayed, transmitted and/or returned via at least one of an API, a GUI, a PDF, a JPEG, an email, or any other document and/or image format.

### IV. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described to be performed by a single computing device, it should be understood that, in some embodiments, different operations may be performed by different networked elements in operative communication with the computing device. For example, at least one computing device 900 may be employed in the performance of some or all of the stages disclosed with regard to the methods. Similarly, an apparatus may be employed in the performance of some or all of the stages of the methods. As such, the apparatus may comprise at least those architectural components as found in computing device 900.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

A. Method for Electronic Trading

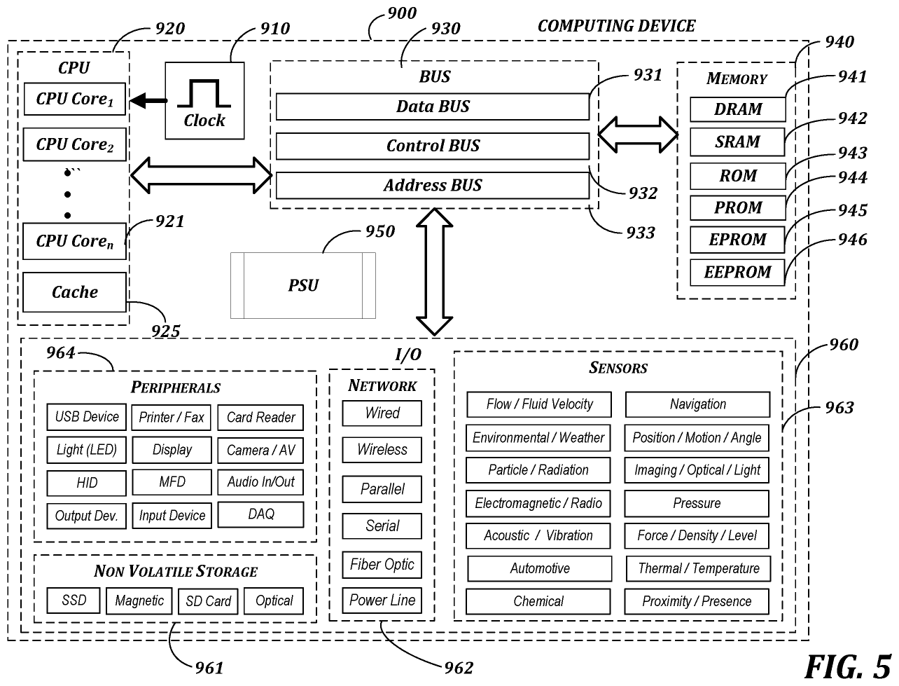

FIG. 2 is a flow chart setting forth general stages involved in a method 500 consistent with embodiments of the disclosure for electronic trading. By way of non-limiting example, Method 500 may be implemented using a computing device 900 or any other component associated with the platform as described in more detail below with respect to FIG. 5. For illustrative purposes alone, computing device 900 is described as one potential actor in aforementioned stages.

### Method 500

The method 500 may begin at stage 502, where a user may create an account and establish a profile within the platform. For example, a user may register within the platform by creating an account. The registration may begin with the user assigning an email ID and a password for the account. The user may establish a connection to a brokerage account and associate the brokerage account with the platform user. In some embodiments, the user may complete a questionnaire, wherein the user may provide a value or selections to a number of attributes and preference which may be a part of the profile. The attributes may include, for example, personal and investment details of the users. The personal details may include, for example, name, date of birth, address and contact number. The investment details may include duration of investment experience, educational background, risk preference, long and short-term investment goals and the like.

In stage 504, the user has the option to create a trading strategy from scratch, or utilize a template from the user marketplace. The user may utilize one or more user interface elements to select whether to create the strategy from scratch or to access the user marketplace.

If the user selects to create a strategy from scratch in stage 504, the method 500 may proceed to stage 506, where the user may create trading strategy from scratch. In some embodiments, creating the trading strategy from scratch may include manually inputting the parameters and attributes associated with the trading strategy. Adjusting the parameters and attributes may modify the trading strategy for particular stocks and/or modify the overall trading strategy such as adjusting one or more of: Stop Loss, Profit Taking, Target, GTC vs GFD, Margin Percentage, and/or other trading strategy attributes.

Additionally or alternatively, creating the trading strategy from scratch may comprise selecting an out of the box (OOTB) proprietary trading strategy template for customization (e.g., by altering one or more parameters and attributes of the template). In embodiments, the platform may include multiple OOTB templates, with each template having a distinct collection of properties. In some embodiments, each of the OOTB templates may be ranked or scored to indicate a similarity between the template properties and the answers provided by the user in the questionnaire completed in stage 502. Following selection of a template, the user may optionally modify or adjust one or more parameters of the template.

Alternatively, if the user selects to access the user marketplace in stage 504, the method 500 may proceed to stage 508, where the user may search the marketplace for a trading strategy. In embodiments, the user may search the marketplace by a number of characteristics, including, as non-limiting examples, user referral, strategy name, performance ranking, and/or the like. In some embodiments, the searching may include the user providing one or more desired values for one or more user trading attributes of the profile. For example, the user trading attributes for the user may include asset type, risk preference, trading experience, and/or others. Further, the attributes may include particular stocks or limits on the overall strategy such as: Stop Loss, Profit Taking, Target, GTC vs GFD, Margin Percentage, and other factors. The platform may provide one or more marketplace postings that include a trading strategy that matches the user search criteria.

For example, each trading strategy published to the marketplace may include one or more values to the attributes which may be used to calculate matching scores and/or display certain trading strategies to the user. For each published trading strategy, a creator may fill in values for the attributes associated with the particular trading strategy. Attributes associated with a published trading strategy may be, for example, average user rating, average rating based on performance, performance data, number of active users, history within marketplace, and other related factors. The user may select a published trading strategy based on, for example, a similarity between the desired attributes entered by the user and the attributes of the published trading strategy. The user may then download the selected published trading strategy from the marketplace and for activation in the user's account.

In some aspects, the platform may employ one or more subscription features. For example, in some embodiments, a subscription may be required to access or utilize published trading strategies or portions of the platform. In still further aspects, the subscription may be tiered (i.e., bronze, silver, gold, etc.). To this end, each tier may provide predefined access to advanced platform features (i.e., real-time trading, performance analysis, additional strategies, etc.). In even further aspects, a user can either create a strategy and pay a subscription for each or use the marketplace and download a strategy, then pay a subscription fee on the selected trading strategy. In some embodiments, the platform may employ a revenue share with the trading strategy provider on the marketplace, for example, from about 1 to about 30% of subscription revenue generated by the trading strategy through the marketplace.

In stage 510, the user may optionally modify the downloaded trading strategy. For example, if permitted by the downloaded trading strategy, the user may modify parameters and attributes such as modification of strategy for particular stocks, and/or limits on the overall trading strategy such as: Stop Loss, Profit Taking, Target, GTC vs GFD, Margin Percentage, and other factors.

Following wither stage 506 or stage 510, the method 500 may continue to stage 512, where the user may select to use a platform proprietary artificial intelligence engine in conjunction with the selected trading strategy. For example, the artificial intelligence engine may be used to influence the weighting on whether to buy or sell in conjunction to the strategy.

If the user selects to use the artificial intelligence in stage 512, the method 500 may proceed to stage 514, where the artificial intelligence may be engaged to monitor and influence strategy decisions made using the selected trading strategy. The artificial intelligence may be engaged in addition to the use of the selected trading model, and may affect the weight given to one or more parameters in the trading model when determining whether or not to initiate a trade (e.g., a buy order or a sell order) and/or how many shares to trade.

Following stage 514, or following stage 512 if the user selects to not engage the artificial intelligence, the method 500 may proceed to stage 516, where the user may select when and where to deploy the selected trading strategy. In particular, the user may determine whether to deploy the selected trading strategy to a live environment (e.g., in actual trading), or to a sandbox environment (e.g., a testing environment). Deploying to the live environment allows the user to begin using the selected trading strategy to make actual trades. Alternatively, deploying the trading strategy to a sandbox allows the trading strategy to function in a simulated environment (e.g., receiving actual information, but without having access to a real wallet or an actual brokerage) such that the user may monitor how the trading strategy functions to ensure the strategy aligns with expectations of the user, without having to commit actual money to the testing. If the user selects to deploy to the live environment the user must also select whether to deploy the testing strategy immediately, or to delay the deployment to the beginning of the next trading day.

If the user selects to deploy to the sandbox environment in stage 516, the method 500 may proceed to stage 518, where the trading strategy is deployed in the sandbox environment on the platform. For example, the platform may provide the trading strategy with the same information it would receive in the live environment, but may refrain from transmitting trades to a broker. Rather, the system may process the trades virtually, such that no money exchanges hands, but the user can track the actions of the trading strategy to ensure that the trading strategy aligns with the user's expectations. In some embodiments, the system may allow the user to transition the trading strategy from the sandbox environment to the live environment if and when the user is satisfied with the test performance of the trading strategy.

If the user selects to deploy to the live environment immediately in stage 516, the method 500 may proceed to stage 520, where the trading strategy is deployed in the live environment on the platform. The platform may immediately begin executing on the selected trading strategy.

If the user selects to deploy to the live environment the next trading day in stage 516, the method 500 may proceed to stage 522, where the trading strategy is held by the platform, to be deployed in the live environment at the start of the next trading day (e.g., the next day that the brokerage and/or marketplace is open. The platform may begin executing on the selected trading strategy once the strategy is deployed (e.g., at the beginning of the next trading day).

B. Method for Executing an Autonomous Electronic Trade

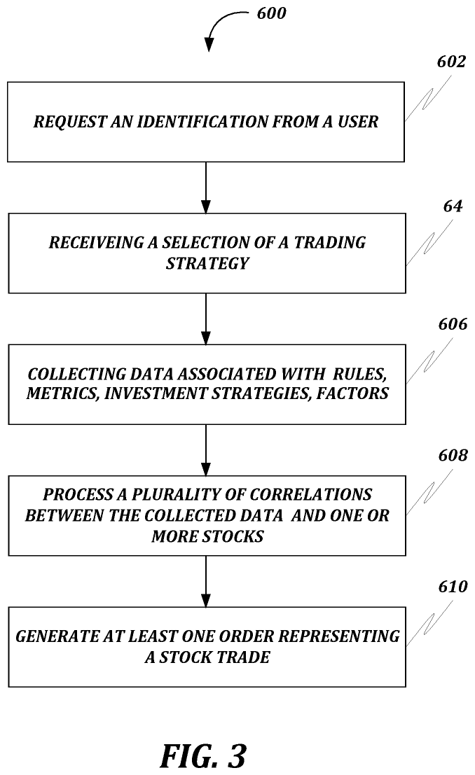

FIG. 3 is a flow chart setting forth the general stages involved in a method 600 consistent with another embodiment of the disclosure for making electronic trades. Method 600 may be implemented using a computing device 900 or any other component associated with platform 100 as described in more detail below with respect to FIG. 5. For illustrative purposes alone, computing device 900 is described as one potential actor in aforementioned stages.

### Method 600

The method 600 may begin at stage 602, where the platform may request an identification from a user. In embodiments the identification may comprise electronic identification, such as a user ID and password. Additionally or alternatively, the identification may comprise user biometric information. For example, a fingerprint scan, a facial recognition scan, a retinal scan, and/or the like may be used as the identification.

In stage 604 the platform may receive a selection of a trading strategy from the user. In some embodiments, the selection of the trading strategy may comprise a user creating a trading strategy from scratch by manually entering the one or more parameters required for the trading strategy. In other embodiments, selection of the trading strategy may comprise selection of an OOTB trading strategy on the platform. In yet other embodiments, selection of the trading strategy may include accessing a user marketplace to select and download a trading strategy created by a user.

The method 600 may proceed to stage 606, where the platform may collect data. In embodiments, the collected data may comprise data associated with rules, metrics, investment strategies, PESTL factors; and/or other factors. In embodiments, the data collection may be performed by, for example, crawling one or more online data sources, data mining techniques, and/or the like. The data may be gathered from a number of disparate sources that may be associated with the platform and/or sources that are independent of the platform. In some embodiments, the data collected may be determined, at least in part, by the selected trading strategy.

In stage 608, the platform may determine one or more correlations and/or associations between the collected data and one or more stock. In embodiments, the platform may use information associated with the stock and/or the company, together with the information gathered in stage 606 to make the one or more correlations and/or associations.

In stage 610 the platform may generate, independent of any user interaction, at least one order representing a stock trade. For example, the order may represent a stock purchase or a stock sale. In embodiments, the stock trade may be generated based on the one or more correlations and/or associations determined in stage 608 and/or the order execution logic included in the trading strategy selected in stage 604. In some embodiments, the stock trade may be submitted to a brokerage such that the stock trade is acted upon on behalf of the user.

### Method for Executing an Autonomous Electronic Trade

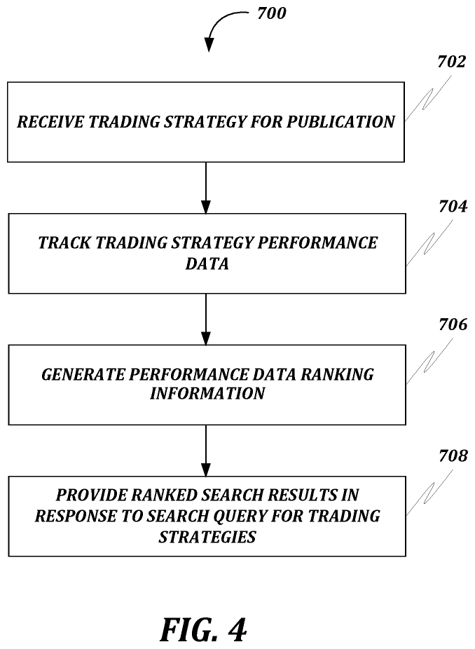

FIG. 4 is a flow chart setting forth the general stages involved in a method 700 consistent with another embodiment of the disclosure for maintaining a user marketplace of trading strategies. Method 700 may be implemented using a computing device 900 or any other component associated with platform 100 as described in more detail below with respect to FIG. 5. For illustrative purposes alone, computing device 900 is described as one potential actor in aforementioned stages.

### Method 700

The method 700 may begin at stage 702, where the platform may receive, from a first user, a trading strategy for publication. The trading strategy may include a plurality of parameters associated with the strategy and execution logic for executing trades.

In stage 704, the platform may track performance data associated with the uploaded trading strategy. In embodiments, tracking performance data may comprise tracking quantitative performance data, such as actual performance of accounts using the trading strategy and/or actual performance of transactions created by the trading strategy. Additionally or alternatively, tracking performance may include tracking qualitative performance data, such as performance information and impressions shared by users on the internet (e.g., on social media sites, forums, and the like), and/or from ratings left by users on the platform. The platform may track the qualitative and/or quantitative performance data. In some embodiments, the performance data may be stored by the platform.

In stage 706 the platform may generate a performance data rank associated with the trading strategy. In some embodiments, the ranking may be relative to other trading strategies stored in the marketplace. Alternatively or additionally, the ranking may be relative to the market at large (e.g., outperforming the market at large, underperforming relative to the market at large). The ranking may be a numerical score. Alternatively, the ranking may be qualitative. For example, trading strategies may be ranked as gold, silver, or bronze based on their performance data.

In stage 708, the system may provide, to a second user, one or more trading strategies. The one or more trading strategies may be selected based on one or more search criteria received from the second user. In some embodiments, the one or more trading strategies may be grouped and/or ranked based on the tracked performance data. In this way, the second user may be provided with user-created trading strategies, together with feedback regarding qualitative and/or quantitative performance of those trading strategies.

### V. Computing Device Architecture

Embodiments of the present disclosure provide a hardware and software platform operative as a distributed system of modules and computing elements.

Platform 100 may be embodied as, for example, but not be limited to, a website, a web application, a desktop application, backend application, and a mobile application compatible with a computing device 900. The computing device 900 may comprise, but not be limited to the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exa-scale supercomputer, a mainframe, or a quantum computer;

A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack mounted, a workstation, an industrial device, a raspberry pi, a desktop, or an embedded device;

Platform 100 may be hosted on a centralized server or a cloud computing service. Although method 500 have been described to be performed by a computing device 900, it should be understood that, in some embodiments, different operations may be performed by a plurality of the computing devices 900 in operative communication at least one network.

Embodiments of the present disclosure may comprise a system having a central processing unit (CPU) 920, a bus 930, a memory unit 940, a power supply unit (PSU) 950, and one or more Input/Output (I/O) units. The CPU 920 coupled to the memory unit 940 and the plurality of I/O units 960 via the bus 930, all of which are powered by the PSU 950. It should be understood that, in some embodiments, each disclosed unit may actually be a plurality of such units for the purposes of redundancy, high availability, and/or performance. The combination of the presently disclosed units is configured to perform the stages any method disclosed herein.

FIG. 4 is a block diagram of a system including computing device 900. Consistent with an embodiment of the disclosure, the aforementioned CPU 920, the bus 930, the memory unit 940, a PSU 950, and the plurality of I/O units 960 may be implemented in a computing device, such as computing device 900 of FIG. 4. Any suitable combination of hardware, software, or firmware may be used to implement the aforementioned units. For example, the CPU 920, the bus 930, and the memory unit 940 may be implemented with computing device 900 or any of other computing devices 900, in combination with computing device 900. The aforementioned system, device, and components are examples and other systems, devices, and components may comprise the aforementioned CPU 920, the bus 930, the memory unit 940, consistent with embodiments of the disclosure.

At least one computing device 900 may be embodied as any of the computing elements illustrated in all of the attached figures, including user input module 200, processing module 300, management module 400, and the method for making electronic trades. A computing device 900 does not need to be electronic, nor even have a CPU 920, nor bus 930, nor memory unit 940. The definition of the computing device 900 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 900, especially if the processing is purposeful.

With reference to FIG. 5, a system consistent with an embodiment of the disclosure may include a computing device, such as computing device 900. In a basic configuration, computing device 900 may include at least one clock module 910, at least one CPU 920, at least one bus 930, and at least one memory unit 940, at least one PSU 950, and at least one I/O 960 module, wherein I/O module may be comprised of, but not limited to a non-volatile storage sub-module 961, a communication sub-module 962, a sensors sub-module 963, and a peripherals sub-module 964.

A system consistent with an embodiment of the disclosure the computing device 900 may include the clock module 910 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 920, the central component of modern computers, which relies on a clock. The only exceptions are asynchronous circuits such as asynchronous CPUs. The clock 910 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 900 use a “clock multiplier” which multiplies a lower frequency external clock to the appropriate clock rate of the CPU 920. This allows the CPU 920 to operate at a much higher frequency than the rest of the computer, which affords performance gains in situations where the CPU 920 does not need to wait on an external factor (like memory 940 or input/output 960). Some embodiments of the clock 910 may include dynamic frequency change, where, the time between clock edges can vary widely from one edge to the next and back again.

A system consistent with an embodiment of the disclosure the computing device 900 may include the CPU unit 920 comprising at least one CPU Core 921. A plurality of CPU cores 921 may comprise identical CPU cores 921, such as, but not limited to, homogeneous multi-core systems. It is also possible for the plurality of CPU cores 921 to comprise different CPU cores 921, such as, but not limited to, heterogeneous multi-core systems, big.LITTLE systems and some AMD accelerated processing units (APU). The CPU unit 920 reads and executes program instructions which may be used across many application domains, for example, but not limited to, general purpose computing, embedded computing, network computing, digital signal processing (DSP), and graphics processing (GPU). The CPU unit 920 may run multiple instructions on separate CPU cores 921 at the same time. The CPU unit 920 may be integrated into at least one of a single integrated circuit die and multiple dies in a single chip package. The single integrated circuit die and multiple dies in a single chip package may contain a plurality of other aspects of the computing device 900, for example, but not limited to, the clock 910, the CPU 920, the bus 930, the memory 940, and I/O 960.

The CPU unit 920 may contain cache 922 such as, but not limited to, a level 1 cache, level 2 cache, level 3 cache or combination thereof. The aforementioned cache 922 may or may not be shared amongst a plurality of CPU cores 921. The cache 922 sharing comprises at least one of message passing and inter-core communication methods may be used for the at least one CPU Core 921 to communicate with the cache 922. The inter-core communication methods may comprise, but not limited to, bus, ring, two-dimensional mesh, and crossbar. The aforementioned CPU unit 920 may employ symmetric multiprocessing (SMP) design.

The plurality of the aforementioned CPU cores 921 may comprise soft microprocessor cores on a single field programmable gate array (FPGA), such as semiconductor intellectual property cores (IP Core). The plurality of CPU cores 921 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 921, for example, but not limited to Instruction-level parallelism (ILP) such as, but not limited to, superscalar pipelining, and Thread-level parallelism (TLP).

Consistent with the embodiments of the present disclosure, the aforementioned computing device 900 may employ a communication system that transfers data between components inside the aforementioned computing device 900, and/or the plurality of computing devices 900. The aforementioned communication system will be known to a person having ordinary skill in the art as a bus 930. The bus 930 may embody internal and/or external plurality of hardware and software components, for example, but not limited to a wire, optical fiber, communication protocols, and any physical arrangement that provides the same logical function as a parallel electrical bus. The bus 930 may comprise at least one of, but not limited to a parallel bus, wherein the parallel bus carry data words in parallel on multiple wires, and a serial bus, wherein the serial bus carry data in bit-serial form. The bus 930 may embody a plurality of topologies, for example, but not limited to, a multidrop/electrical parallel topology, a daisy chain topology, and a connected by switched hubs, such as USB bus. The bus 930 may comprise a plurality of embodiments, for example, but not limited to:
Internal data bus (data bus) 931/Memory bus
Control bus 932
Address bus 933
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal 10, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 900 may employ hardware integrated circuits that store information for immediate use in the computing device 900, know to the person having ordinary skill in the art as primary storage or memory 940. The memory 940 operates at high speed, distinguishing it from the non-volatile storage sub-module 961, which may be referred to as secondary or tertiary storage, which provides slow-to-access information but offers higher capacities at lower cost. The contents contained in memory 940, may be transferred to secondary storage via techniques such as, but not limited to, virtual memory and swap. The memory 940 may be associated with addressable semiconductor memory, such as integrated circuits consisting of silicon-based transistors, used for example as primary storage but also other purposes in the computing device 900. The memory 940 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 941, Static Random-Access Memory (SRAM) 942, CPU Cache memory 925, Advanced Random-Access Memory (A-RAM), and other types of primary storage such as Random-Access Memory (RAM).
Non-volatile memory which can retain stored information even after power is removed, for example, but not limited to, Read-Only Memory (ROM) 943, Programmable ROM (PROM) 944, Erasable PROM (EPROM) 945, Electrically Erasable PROM (EEPROM) 946 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 900 may employ the communication system between an information processing system, such as the computing device 900, and the outside world, for example, but not limited to, human, environment, and another computing device 900. The aforementioned communication system will be known to a person having ordinary skill in the art as I/O 960. The I/O module 960 regulates a plurality of inputs and outputs with regard to the computing device 900, wherein the inputs are a plurality of signals and data received by the computing device 900, and the outputs are the plurality of signals and data sent from the computing device 900. The I/O module 960 interfaces a plurality of hardware, such as, but not limited to, non-volatile storage 961, communication devices 962, sensors 963, and peripherals 964. The plurality of hardware is used by the at least one of, but not limited to, human, environment, and another computing device 900 to communicate with the present computing device 900. The I/O module 960 may comprise a plurality of forms, for example, but not limited to channel I/O, port mapped I/O, asynchronous I/O, and Direct Memory Access (DMA).

Consistent with the embodiments of the present disclosure, the aforementioned computing device 900 may employ the non-volatile storage sub-module 961, which may be referred to by a person having ordinary skill in the art as one of secondary storage, external memory, tertiary storage, off-line storage, and auxiliary storage. The non-volatile storage sub-module 961 may not be accessed directly by the CPU 920 without using intermediate area in the memory 940. The non-volatile storage sub-module 961 does not lose data when power is removed and may be two orders of magnitude less costly than storage used in memory module, at the expense of speed and latency. The non-volatile storage sub-module 961 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (961) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 900 may employ the communication sub-module 962 as a subset of the I/O 960, which may be referred to by a person having ordinary skill in the art as at least one of, but not limited to, computer network, data network, and network. The network allows computing devices 900 to exchange data using connections, which may be known to a person having ordinary skill in the art as data links, between network nodes. The nodes comprise network computer devices 900 that originate, route, and terminate data. The nodes are identified by network addresses and can include a plurality of hosts consistent with the embodiments of a computing device 900. The aforementioned embodiments include, but not limited to personal computers, phones, servers, drones, and networking devices such as, but not limited to, hubs, switches, routers, modems, and firewalls.

Two nodes can be said are networked together, when one computing device 900 is able to exchange information with the other computing device 900, whether or not they have a direct connection with each other. The communication sub-module 962 supports a plurality of applications and services, such as, but not limited to World Wide Web (WWW), digital video and audio, shared use of application and storage computing devices 900, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 962 may comprise a plurality of size, topology, traffic control mechanism and organizational intent. The communication sub-module 962 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 900 may employ the sensors sub-module 963 as a subset of the I/O 960. The sensors sub-module 963 comprises at least one of the devices, modules, and subsystems whose purpose is to detect events or changes in its environment and send the information to the computing device 900. Sensors are sensitive to the measured property, are not sensitive to any property not measured, but may be encountered in its application, and do not significantly influence the measured property. The sensors sub-module 963 may comprise a plurality of digital devices and analog devices, wherein if an analog device is used, an Analog to Digital (A-to-D) converter must be employed to interface the said device with the computing device 900. The sensors may be subject to a plurality of deviations that limit sensor accuracy. The sensors sub-module 963 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 900 may employ the peripherals sub-module 962 as a subset of the I/O 960. The peripheral sub-module 964 comprises ancillary devices uses to put information into and get information out of the computing device 900. There are 3 categories of devices comprising the peripheral sub-module 964, which exist based on their relationship with the computing device 900, input devices, output devices, and input/output devices. Input devices send at least one of data and instructions to the computing device 900. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 900. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 964:
Input Devices
   Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 900. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 900 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 900. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers and plotters.
   Audio and Video (AV) devices, such as, but not limited to, speakers, headphones, amplifiers and lights, which include lamps, strobes, DJ lighting, stage lighting, architectural lighting, special effect lighting, and lasers.
   Other devices such as Digital to Analog Converter (DAC).
Input/Output Devices may further comprise, but not be limited to, touchscreens, networking device (e.g., devices disclosed in network 962 sub-module), data storage device (non-volatile storage 961), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

### VI. Aspects

The following disclose various Aspects of the present disclosure. The various Aspects are not to be construed as patent claims unless the language of the Aspect appears as a patent claim. The Aspects describe various non-limiting embodiments of the present disclosure.

Aspect 1. Take in raw data that has been collected over a period of time and augment it using a variety of techniques.
Aspect 2. Application system includes a microservice approach to solving this problem and will include the following systems, technologies and man hours to complete.
Aspect 3. Languages used for this project include Python, SQL, HTML, Bash, and JavaScript.
Aspect 4. An electronic trading platform comprising:
a user interface (UI) module,
   wherein the UI module provides an interface for at least one of the following:
      creating a user profile with a plurality of user input data;
      opening an order with a generation or creation of an order object,
      accepting or executing the order and complete the order object, and
   creating a trading strategy with a generation or creation of a trading strategy object or template;
      selection of a trading strategy object, wherein the trading strategy object is enabled to view the user input data and open and execute orders on behalf of a user,
a processing module,
   wherein the processing module is configured to perform at least one of the following:
      collect data related to stocks and holdings,
      associate the collected data to stocks or holding using attributes;
      analyze the attribution data according to predetermined criteria, and a management module,
   wherein the management module is configured to perform at least one of the following:
      generating and/or executing order object based on at least one of:
         a selection or instruction from a user, or
         instruction from order logic associated with a trading strategy,
         wherein the instruction from the order logic is at least based on the analyzed attribution data.
            Aspect 5. The platform of Aspect 4, wherein the processing module comprises a natural language processing (NLP) capability.
            Aspect 6. The platform of Aspect 4, wherein the user input module comprises a graphical user interface (GUI).
            Aspect 7. A method for making electronic trading, the method comprising:
creating a user profile with a plurality of user input data;
   opening an order with a generation or creation of an order object,
   accepting or executing the order and complete the order object, and
creating a trading strategy with a generation or creation of a trading strategy object or template;
selection of a trading strategy object, wherein the trading strategy object is enabled to view the user input data and open and execute orders on behalf of a user;
   collecting data related to stocks and holdings,
   associating the collected data to stocks or holding using attributes;
   analyzing the attribution data according to predetermined criteria; and
   generating and/or executing order object based on at least one of:
      a selection or instruction from a user, or
      instruction from order logic associated with a trading strategy,
wherein the instruction from the order logic is at least based on the analyzed attribution data.

### VII. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

Although very narrow claims are presented herein, it should be recognized the scope of this disclosure is much broader than presented by the claims. It is intended that broader claims will be submitted in an application that claims the benefit of priority from this application.

The following is claimed:

1. One or more non-transitory computer readable media comprising instructions which, when executed by one or more hardware processors, causes performance of operations comprising:
creating a user profile;
associating an automated trading strategy with the user profile;
modifying the automated trading strategy based on one or more user preferences; and
executing a trade based on the modified automated trading strategy.

2. The one or more non-transitory computer readable media of claim 1, wherein the automated trading strategy comprises one or more parameters, and execution logic for executing the trade.

3. The one or more non-transitory computer readable media of claim 2, wherein associating the automated trading strategy with the user profile comprises receiving one or more input specifying the one or more parameters.

4. The one or more non-transitory computer readable media of claim 2, wherein associating the automated trading strategy with the user profile comprises receiving a selection of an out of the box automated trading strategy.

5. The one or more non-transitory computer readable media of claim 2, wherein associating the automated trading strategy with the user profile comprises receiving a selection of a user-created automated trading strategy form a user marketplace.

6. The one or more non-transitory computer readable media of claim 2, wherein executing the trade comprises:
collecting data associated with the one or more parameters of the automated trading strategy;
processing the collected data to determine one or more correlations between the collected data and a particular stock; and
executing a trade of the particular stock based on the determined one or more correlations and the execution logic of the automated trading strategy.

7. The one or more non-transitory computer readable media of claim 6, wherein processing the collected data comprises utilizing a trained machine learning model to determine the one or more correlations.

8. The one or more non-transitory computer readable media of claim 1, wherein the trade comprises one of:
a stock purchase; or
a stock sale.

9. The one or more non-transitory computer readable media of claim 1, the operations further comprising receiving feedback related to the performance of the automated trading strategy.

10. A method comprising:
creating a user profile;
associating an automated trading strategy with the user profile;
modifying the automated trading strategy based on one or more user preferences; and
executing a trade based on the modified automated trading strategy;
wherein the method is performed by at least one device including a hardware processor.

11. The method of claim 10, wherein the automated trading strategy comprises one or more parameters, and execution logic for executing the trade.

12. The method of claim 11, wherein associating the automated trading strategy with the user profile comprises receiving one or more input specifying the one or more parameters.

13. The method of claim 11, wherein associating the automated trading strategy with the user profile comprises receiving a selection of an out of the box automated trading strategy.

14. The method of claim 11, wherein associating the automated trading strategy with the user profile comprises receiving a selection of a user-created automated trading strategy form a user marketplace.

15. The method of claim 11, wherein executing the trade comprises:
collecting data associated with the one or more parameters of the automated trading strategy;
processing the collected data to determine one or more correlations between the collected data and a particular stock; and
executing a trade of the particular stock based on the determined one or more correlations and the execution logic of the automated trading strategy.

16. The method of claim 15, wherein processing the collected data comprises utilizing a trained machine learning model to determine the one or more correlations.

17. The method of claim 10, wherein the trade comprises one of:
a stock purchase; or
a stock sale.

18. The method of claim 10, further comprising receiving feedback related to the performance of the automated trading strategy.

19. A system comprising:
at least one device including a hardware processor;
the system being configured to perform operations comprising:
creating a user profile;
associating an automated trading strategy with the user profile, the automated trading strategy comprising one or more parameters, and execution logic for executing a trade;
modifying the automated trading strategy based on one or more user preferences; and
executing a trade based on the modified automated trading strategy.

20. The system of claim 19, wherein executing the trade comprises:
collecting data associated with the one or more parameters of the automated trading strategy;
processing the collected data to determine one or more correlations between the collected data and a particular stock; and
executing a trade of the particular stock based on the determined one or more correlations and the execution logic of the automated trading strategy.
